(19) United States
(12) Patent Application Publication
(10) Pub. No.: US 2003/0118109 A1
(43) Pub. Date: Jun. 26, 2003

(54) Video compression using sub-sampling

(76) Inventors: Simon Kelly, Hertfordshire (GB); Trevor Grant Clarkson, Kent (GB); Il-Song Han, Bedfordshire (GB)

Correspondence Address: William J Sapone, Coleman Sudol Sapone, 714 Colorado Avenue, Bridgeport, CT, 06605-1601, US

(21) Appl. No.: 10/220,529

(22) PCT Filed: Jan. 24, 2001
(86) PCT No.: PCT/GB01/00264

(51) Int. Cl. H04B 1/66

(52) U.S. Cl. 375/240.21; 375/240.01

(57) ABSTRACT

A video signal is compressed by alternately removing predetermined arrangements of pixels, e.g. odd and even lines. In the case of an interlaced video signal, this may comprise removing the even fields of odd frames and odd fields of even frames. Two such compressed signals may be combined and transmitted in a channel having a bandwidth sufficient for one uncompressed signal only. In the case of non-interlaced video signals, odd and even lines, for example, may be removed from alternate frames. The removed lines can be replaced with odd and even lines taken from another video signal to produce a compressed video signal in which the lines are alternately from first and second uncompressed video signals.

### FIELD OF THE INVENTION

The present invention relates to video compression and decompression.

### BACKGROUND TO THE INVENTION

Real time uncompressed video that provides a viewer with a smoothly moving images requires a large bandwidth, typically 5.2 MHz for a PAL broadcast television signal. Much work has therefore been put into compressing video signals to that they can be transmitted through relatively narrow channels. On result of this work is the MPEG system which can offer compression rates of the order of 30:1. However, MPEG is computationally intensive at both the coding and decoding ends and the viewed image at high compression ratios takes on a “blocky” appearance that is undesirable.

### SUMMARY OF THE INVENTION

It is an aim of the present invention to provide a compression system for video signals that requires relatively simple processing at the receiving end whilst achieving a significant level of compression and minimising disruption of the decompressed image by compression artefacts.

According to the present invention, there is provided a method of compressing a video signal, the method comprising:

removing a first set of pixels or lines from a first frame of the video signal comprising a plurality of frames; and

removing second set of pixels or lines from a second immediately succeeding frame of the video signal such that the same line is not removed from both frames.

The lines may be removed such that a total of N lines from M frames are output, where N is the number of lines in a frame. N/M lines from each frame may be output. However, differing numbers of lines may be output from different frames. Preferably, however, the first set of lines comprises alternate lines.

Conveniently, where each frame of the video signal comprised two interlaced fields, the second field is removed from the first frame and the first field is removed from the second frame.

Compressed video signals produced according to the present invention may be transmitted. Indeed, a plurality of compressed video signals in can be transmitted in the channel normally required for one channel. The number of channels that can be so transmitted will depend on the value M. Where M is 2, the transmission method may comprise alternately transmitting parts of the first and second video signals remaining after said compression.

Where first and second signals are being transmitted in compressed form, the transmitted signal preferably comprises alternating frame-sized parts of the first and second video signals. Alternatively, the transmitted signal may comprise alternating lines from the first and second video signals.

According to the present invention, there is also provided a method of decompressing a video signal produced by a method according to the present invention, the method comprising:

replacing missing pixels by combining in a predetermined manner spatially and/or temporally neighbouring pixels. Neighbouring pixels need not be immediate neighbours.

According to the present invention, there is further provided a method of decompressing a video signal comprising alternate fields of alternate frames, the method comprising receiving a frame-sized portion of the compressed signal and outputting said portion twice.

According to the present invention, there is yet further provided a method of decompressing a video signal, the method comprising:

receiving a signal comprising alternate fields of alternate frames; and

replacing missing pixels by combining in a predetermined manner spatially and/or temporally neighbouring pixels. Neighbouring pixels need not be immediate neighbours.

Preferably, a missing pixel is replaced by selectively outputting a pixel from a previously received field or by outputting the result of said combining in dependence on the difference between the pixels, corresponding to the missing pixel, in the preceding and succeeding received fields of the same type as that for which the missing pixel is being replaced.

More preferably, missing pixels of an odd field, i.e. a first field of a frame, are replaced by combining the corresponding pixels of the preceding and succeeding odd fields, the pixels immediately preceding and succeeding said corresponding pixels, the pixel of the preceding or succeeding even field which is immediately above the pixel to be replaced and the pixels on either side thereof. Said combining may comprise calculating the mean, or some other average, of the values of said pixels for each of a plurality of video components, for instance by convolving said pixels with a predetermined convolution mask. Preferably, said combining comprises, for each of a plurality of video components, convolving the values of said pixels with −1, 1, −1 for the preceding and succeeding odd fields and 1, 1, 1 for said preceding or succeeding even field and summing the results thereof.

Preferably, missing pixels of an even field, i.e. a second field of a frame, are replaced by combining the corresponding pixels of the preceding and succeeding even fields, the pixels immediately preceding and succeeding said corresponding pixels, the pixel of the preceding or succeeding odd field which is immediately above the pixel to be replaced and the pixels on either side thereof. Said combining may comprise calculating the mean, or some other average, of the values of said pixels for each of a plurality of video components. Preferably, however, said combining comprises, for each of a plurality of video components, convolving the values of said pixels with −1, 1, −1 for the preceding and succeeding odd fields and 1, 1, 1 for said preceding or succeeding odd field and summing the results thereof.

According to the present invention, there is also provided video compression apparatus configured to perform a video compression method according to the present invention.

In particular, there is provided a video decompression apparatus for decompressing video in the form of alternate fields of alternate frames, the apparatus comprising:

memory for storing compressed video signal data;

a convolver for convolving data from said memory with a predetermined mask to regenerate pixels of a field for which data is not contained in the memory; and

switching means for selectively outputting video data for said memory or from the convolver in dependence on the presence of data for the currently output field in the memory.

Preferably, the apparatus includes comparing means for comparing the difference between corresponding pixels of fields output from the memory and a threshold, and further switching means for selectively routing one of said corresponding pixels or the output of the convolver to said switching means for selectively outputting video data in dependence on the output of the comparing means.

The apparatus may include addressing means for controlling writing of data to the memory such that for the regeneration of a pixel of an odd field by the convolver, the memory has available the corresponding pixels of the preceding and succeeding odd fields, the pixels immediately preceding and succeeding said corresponding pixels, the pixel of the preceding or succeeding even field which is immediately above the pixel to be replaced and the pixels on either side thereof. The apparatus may also include addressing means for controlling writing of data to the memory such that for the regeneration of a pixel of an even field by the convolver, the memory has available the corresponding pixels of the preceding and succeeding even fields, the pixels immediately preceding and succeeding said corresponding pixels, the pixel of the preceding or succeeding odd field which is immediately above the pixel to be replaced and the pixels on either side thereof.

Preferably, the convolver has three sections for processing pixels from respective fields and adding means for summing the outputs of said sections.

Each section of the convolver may comprise first, second and third multiplying means for multiplying by 1/9 or approximately 1/9, first and second one-pixel delays and first and second adders, the first multiplying means being connected between the section's input and the first adder, the first delay being connected between said input and the second multiplying means, the output of the second multiplying means being connected to the first adder, the second delay being connected between the output of the first delay and the third multiplying means, and the outputs of the third multiplying means and the first adder being connected to the inputs of the second adder.

Preferably, however, the convolver sections for processing pixels of the preceding and succeeding fields of the same type as that being restored each comprise first and second multiplying means for multiplying by −1, first and second one-pixel delays and first and second adders, the first delay being connected between the section's input and the first adder, the second delay being connected between the first delay and the second multiplying means, the output of the second multiplying means is connected to the second adder and the output of the first adder being connected to the second adder, and the other section comprises first and second one-pixel delays and first and second adders, the first and second delays being connected in series with the first delay connected to the section's input, the first adder having its inputs connected to the section's input and the output of the first delay, and the second adder having its inputs connected to the outputs of the first adder and the second delay.

### BRIEF DESCRIPTION OF THE DRAWINGS

FIG. 1 shows a first video compression apparatus according to the present invention;

FIG. 2 shows waveforms output by the pre-processor in FIG. 1;

FIG. 3 is a circuit diagram of the control signal generator in FIG. 1;

FIG. 4 is a circuit diagram of the address generator of FIG. 1;

FIG. 5 shows a first video decompression apparatus according to the present invention;

FIG. 6 is a circuit diagram of the address generator in FIG. 5;

FIG. 7 shows a second video decompression apparatus according to the present invention;

FIG. 8 is a block diagram of the convolver for FIG. 7;

FIG. 9 illustrates the reading and writing of the memories of FIG. 7;

FIG. 10 illustrates the operation of the switching circuit of FIG. 7;

FIG. 11 illustrates a control signal from FIG. 7;

FIG. 12 is a circuit diagram a circuit for multiplying 2's complement numbers by −1;

FIG. 13 is a block diagram of an alternative convolver for the decompression apparatus of FIG. 7;

FIG. 14 is a block diagram of a compressed video communications system according to the present invention;

FIG. 15 is a circuit diagram of part of a second video compression system according to the present invention;

FIG. 16 illustrates the output of the circuit in FIG. 8; and

FIG. 17 shows a third video decompression apparatus according to the present invention.

### DETAILED DESCRIPTION OF THE PREFERRED EMBODIMENTS

Embodiments of the present invention will now be described, by way of example, with reference to the accompanying drawings.

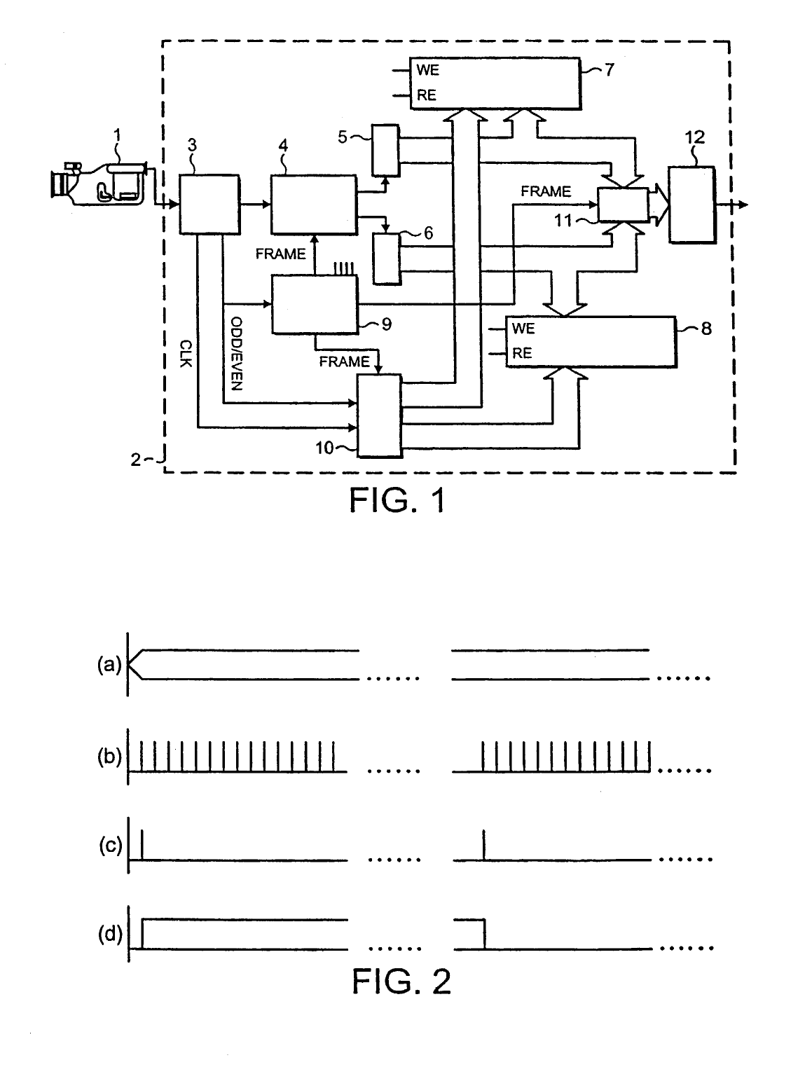

Referring to FIG. 1, a video camera 1 is connected to a first video compression system 2 according to the present invention. The video compression system comprises an analogue-to-digital conversion and pre-processing circuit 3 (hereinafter the “pre-processor”) connected to receive the composite video signal output by the video camera 1. Referring to FIG. 2, the pre-processor 3 outputs a digital 4:2:2 (CCIR 601) video signal FIG. 2(a)), vertical and horizontal sync signals (FIGS. 2(b) and 2(c)), an odd/even field signal (FIG. 2(d)) and a clock signal.

The digital output of the pre-processor 3 is applied to the input of a switch 4. The two outputs of the switch 4 are connected to respective serial-to-parallel converters 5, 6 and the outputs of the serial-to-parallel converters 5, 6 are connected to the input data terminals of respective RAMs 7, 8.

The odd/even field signal is applied to an input of a control signal generating circuit 9. The control signal generating circuit 9 produces a “frame” signal for controlling the switch 4 and the read and write enable signals for the RAMs 7, 8. A multiplexer 11 selects the output of one of the RAMs 7, 8 in response to the frame signal from the control signal generating circuit 9. The multiplexer 11 responds to this signal such that the output of the RAM 7, 8 being read is passed. A parallel-to-serial converter 12 follows the multiplexer 11.

The frame signal, the odd/even field signal and the clock signal are input into an address generator 10 for generating addresses for the RAMs 7, 8.

Each frame of the composite video signal from the video camera 1 comprises an odd field and an even field which are interlaced. In order to achieve compression of the video signal from the video camera 1, the present invention alternately discards the even field or the odd field from each frame. Thus, in a first frame the even field is discarded, in a second frame the odd field is discarded, in a third frame the even field is discarded and so on.

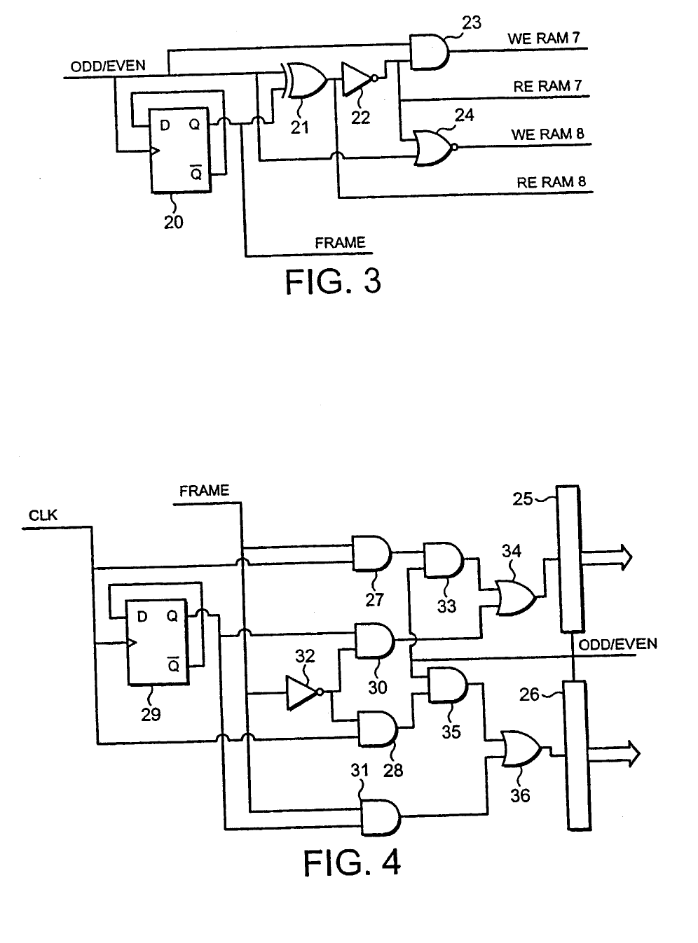

Referring to FIG. 3, the frame signal for controlling the switch 4 is produced by the control signal generating circuit 9. In the control signal generating circuit 9, the odd/even field signal is applied to the clock input of a D-type flip-flop 20 which has its input connected to its inverted output. The non-inverted output of the D-type flip-flop 20 thus changes state with each frame.

The non-inverted output of the D-type flip-flop 20 is also connected to one input of a two-input exclusive OR gate 21, the other input of which receives the odd/even signal. The output of the exclusive OR gate 21 provides the read enable signal for the second RAM 8 and is also inverted by an inverter 22. The output of the inverter 22 provides the read enable signal for the first RAM 7. The output of the inverter 22 is also connected to one input of a two-input AND gate 23 and to one input of a two-input NOR gate 24. The other input of the AND gate 23 receives the odd/even signal and its output is the write enable signal for the first RAM 7. The other input of the NOR gate 24 receives the odd/even signal and its output is the write enable signal for the second RAM 8.

Thus for each pair of frames, comprising an “odd” frame (1^{st}, 3^{rd}, 5^{th}, 7^{th} . . . ) and an “even” frame (2^{nd}, 4^{th}, 6^{th}, 8^{th} . . . ), the first RAM 7 will be write enabled during the odd field period of the “odd” frame and read enabled during the whole of the “even” frame and the second RAM 8 will be read enabled during the whole of the “odd” frame and write enables during the even field of the “even” frame.

The horizontal sync, frame and odd/even signals are input, together with the analogue-to-digital conversion clock, into an address generator 10.

Referring to FIG. 4, the address generator 10 comprises a first counter 25 for addressing the first RAM 7 and a second counter 26 for addressing the second RAM 8. Each of the counters 25, 26 has a reset input to which the odd/even signal is applied.

The clock signal is applied to one of the inputs of each of first and second two-input AND gates 27, 28 and to the clock input of a D-type flip-flop 29 for halving the frequency of the clock to produce a half-rate clock signal. The output of the D-type flip-flop 29 is connected to one of the inputs of each of third and fourth two-input AND gates 30, 31.

The frame signal is routed to the other inputs of the first and fourth two-input AND gates 27, 31 directly and to the other inputs of the second and third two-input AND gates 28, 29 via an inverter 32.

The output of the first two-input AND gate 27 is connected to one input of a fifth two-input AND gate 33, the other input of which is arranged to receive the odd/even signal. The output of the fifth two-input AND gate 33 and the output of the third two-input AND gate 30 are connected to respective inputs of a first two-input OR gate 34. The output of the first two-input OR gate 34 is connected to the clock input of the first counter 25.

The output of the second two-input AND gate 28 is connected to one input of a sixth two-input AND gate 35, the other input of which is inverted and arranged to receive the odd/even signal. The output of the sixth two-input AND gate 35 and the output of the fourth two-input AND gate 31 are connected to respective inputs of a second two-input OR gate 36. The output of the second two-input OR gate 36 is connected to the clock input of the second counter 22.

The operation of the video compression system of FIG. 1 will now be described.

At the start of an odd frame, the odd/even signal is output by the pre-processor 3 to the address generator 10 where its rising edge resets the counters 25, 26. The control signal generating circuit 9 outputs the frame signal to the switch 4 and the multiplexer 11 in the state required for the digitised video to be routed to the first parallel-to-serial converter 5 and the output of the second RAM 8 to be passed by the multiplexer 11.

At the same time, the control signal generating circuit 9 sets the write enable signal for the first RAM 7 and the read enable signal for the second RAM 8 to true and the read enable signal for the first RAM 7 and the write enable signal for the second RAM 8 to false.

In the address generator 10, the counters 25, 26 begin to count. The first counter 25 counts at the rate of the clock signal and the second counter 26 counts at half the rate of the clock signal. The output of the first counter 25 is applied to the address inputs of the first RAM 7 which stores successive video samples from the first serial-to-parallel converter 5 in the addressed locations. The output of the second counter 26 is applied to the address inputs of the second RAM 8 which outputs the values at the addressed locations to the multiplexer 11 which passes them on to the parallel-to-serial converter 12 for further transmission.

When the odd field of the present “odd” frame ends, the first counter 25 stops counting because the clock signals are blocked by the fifth two-input AND gate 33. However, the second counter 26 continues counting until the end of the frame.

At the end of the “odd” frame, the rising edge of the odd/even signal again resets the counters 25, 26 and the frame signal changes state so that the second RAM 8 will be written to and the first RAM 7 will be read from.

In the address generator, the first counter 25 immediately starts counting the half-rate clock pulses, causing data to be read from the first RAM 7. However, the sixth two-input AND gate 35 prevents the clock pulses reaching the second counter 26 until the even field starts.

It can be seen, therefore, that the data output from the multiplexer 12 has half the rate of the data output by the pre-processor 3 and that the even field of “odd” frames and the “odd” fields of even frames have been discarded.

A decompression apparatus for the signal produced by the compression system of FIG. 1 will now be described.

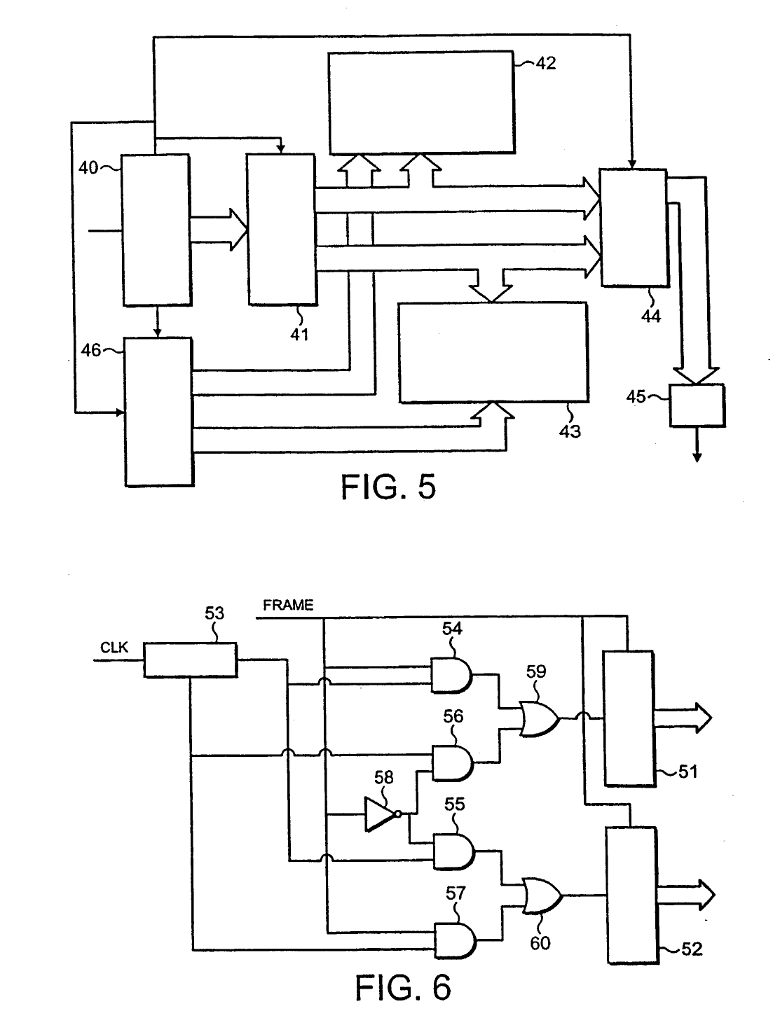

Referring to FIG. 5, a video decompression apparatus comprises a pre-processor 40, a switch 41, a first RAM 42, a second RAM 43, a multiplexer 44, a parallel-to-serial converter 45 and an address generator 46.

The pre-processor 40 receives a compressed signal such as is produced by the system described above, performs serial-to-parallel conversion, extracts a clock signal from the input signal, identifies the start of each field from vertical blanking period codes in the input signal, and generates an “odd/even” frame signal and read and write enable signals for the RAMs 42, 43. The clock signal has a frequency which is half of the bit rate of the input signal.

The odd/even frame signal is output to the switch 41 and the multiplexer 44 to control the routing of video signals. The clock signal and the “odd/even” frame signal are output to the address generator 46.

Referring to FIG. 6, the address generator 46 includes first and second counters 51, 52 which can each count from 0 to one less than the number of samples in a frame i.e. two fields. They are also resettable by the “odd/even” frame signal. The first counter 51 provides address signals for the first RAM 42 and the second counter 52 provides address signals for the second RAM 43.

A frequency divider circuit 53 divides the clock signal from the pre-processor 40 to produce first and second local clock signals. The first local clock signal has a frequency equivalent to the sample rate of the input compressed video signal and the second local clock signal has a frequency twice that of the first local clock. The first local clock is supplied to one input of each of first and second two-input AND gates 54, 55. The second local dock is supplied to one input of each of third and fourth two-input AND gates 56, 57. The other inputs of the first and fourth two-input AND gates 54, 57 are connected to receive the “odd/even” frame signal. The “odd/even” frame signal is also supplied to the input of an inverter 58, the output of which is connected to the other inputs of the second and third two-input AND gates 55, 56. The outputs of the first and third two-input AND gates 54, 56 are connected to the inputs of a first two-input OR gate 59. The output of the first two-input OR gate 59 is connected to the clock input of the first counter 51. The outputs of the second and fourth two-input AND gates 55, 57 are connected to the inputs of a second two-input OR gate 60. The output of the second two-input OR-gate 60 is connected to the clock input of the first counter 52.

The operation of the decompression apparatus will now be described.

When a compressed video signal is received by the pre-processor 40, the clock signal is extracted and sent to the address generator 46. The detection of the start of the video coincides with the start of the first frame which is, of course, an odd frame. Accordingly, the switch 41 directs the video data to the first RAM 42 and the multiplexer 44 passes data from the second RAM 43.

In the address generator, the first counter 51 starts counting the first local clock thereby sequentially addressing the first RAM 42 so that the video data from the pre-processor 40 is written into it. The second counter 52 starts counting the second local clock thereby sequentially addressing the second RAM 43. However, at this stage there is no data in the second RAM to be read out.

When the first frame comes to an end, the switch 41 is switched to feed video data to the second RAM 43 and the multiplexer 44 passes data from the first RAM 42. In the address generator, the first counter start to count the second local clock and the second counter starts to count the first local clock. In this way, the video data from the pre-processor 40 is loaded into the second RAM 43 and the data from the previous frame is read from the first RAM 42 and output via the multiplexer 44 and the parallel-to-serial converter 45. Since, the first counter 51 is now counting twice as fast as the second counter 52, the contents of the first RAM 42 are read out twice during the writing of one frame into the second RAM 43. Consequently, the original, uncompressed frame rate is restored.

Another decompression apparatus, suitable for decompressing signals produced by the apparatus of FIG. 1, will now be described.

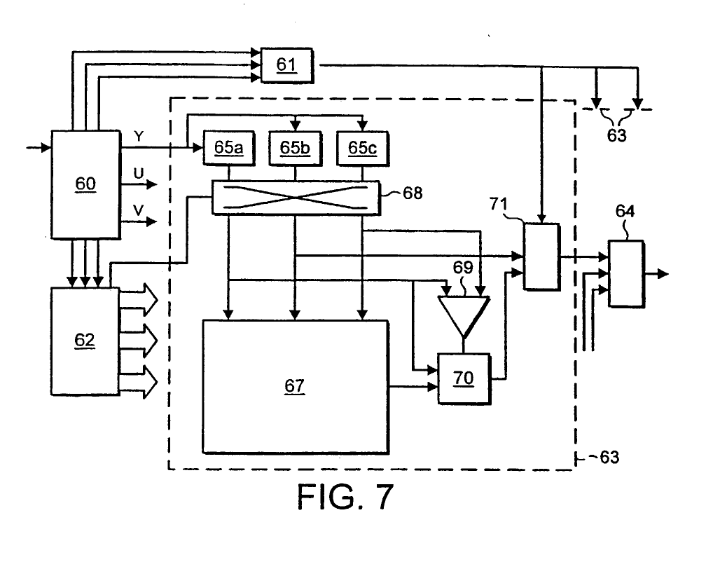

Referring to FIG. 7, a video decompression apparatus comprises a pre-processing circuit 60, a switching signal generator 61, a memory address signal generator 62, first, second and third processing circuits 63 (one each for Y, U (R-Y) and V (B-Y) video component signals but only one shown) and a composite video signal generator 64.

The first processing circuit 63 comprises first, second and third video RAMs 65a, 65b, 65c, a convolver 67, a switching matrix 68 connecting the outputs of the video RAMs 65a, 65b, 65c to the three inputs of the convolver 67, a comparing circuit 69, a first output switch 70 and a second output switch 71. The comparing circuit 69 has two inputs coupled respectively to first and third outputs of the switching matrix 68. The output of the comparing circuit 69 is connected to the control input of the first output switch 70. The state of the output of the comparing circuit 69 is dependent on whether the magnitude of the difference between the inputs to the comparing circuit 69 exceeds a threshold value. The first output switch 70 has two data inputs connected respectively to the output of the convolver 67 and the first output of the switching matrix 68. The output of the first output switch 70 is connected to one data input of the second output switch 71. The second output switch 71 has a second input connected to the second output of the switching matrix 68 and a control input which receives a control signal from the switching signal generator 61. The switching signal generator 61 generators a switching signal for the second output switch 71 from clock, frame and field signals that it receives from the pre-processing circuit 60.

The addressing and read and write enabling of the video RAMs 65a, 65b, 65c is effected by the outputs of the address generator 62. The address generator 62 also generates a switching signal for the switching matrix 68. The address generator 62 generates these signals from clock, frame and field signals from the pre-processor 60.

The pre-processing circuit 60 receives a colour composite video signal, in this case a PAL signal, and generates digital Y, U, V video component signals therefrom. It also outputs a clock signal which is synchronised with the sampling of the input video signal, a frame signal indicating the start of each frame and a field signal indicating whether the current field is odd or even.

The video component signals from the pre-processing circuit 60 are written into the video RAMs 65a, 65b, 65c of respective processing circuits 63 under the control of the address signal generator 62.

The second and third processing circuits are identical to the first processing circuit 63.

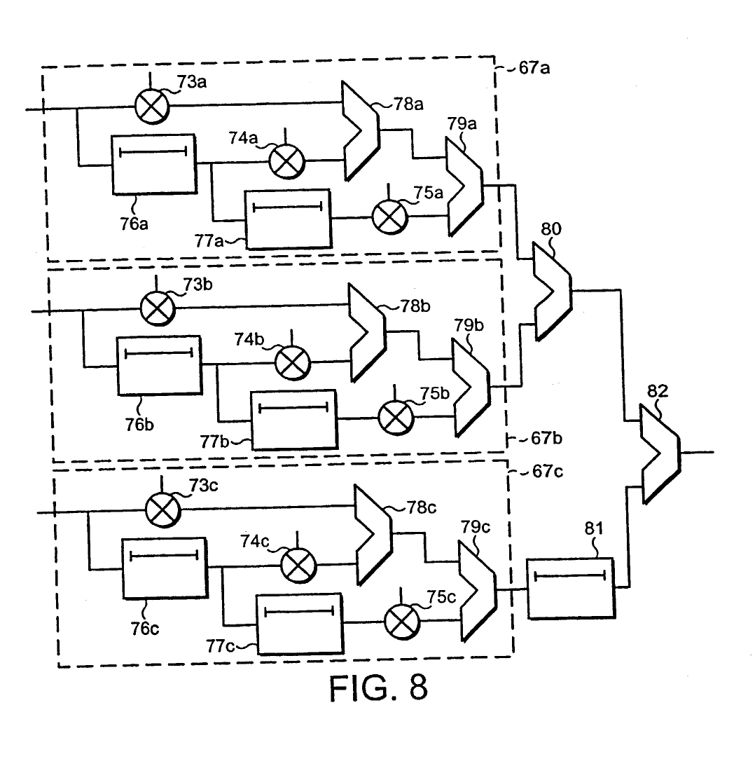

Referring to FIG. 8, the convolver 67 comprises first, second and third section 67a, 67b, 67c whose inputs are respectively the first, second and third inputs of the convolver 67.

The first section 67a comprises first, second and third multipliers 73a, 74a, 75a, first and second one-pixel delays 76a, 77a and first and second adders 78a, 79a. The first multiplier 73a has one input connected to receive signals input at the first input of the convolver 67 and multiplies it by 1/9. The multiplication by 1/9 can be approximated by right shifting the pixel values by 3 places and subtracting one eighth of the result (i.e. X×0.125−(X×0.125×0.125)=X×(0.125−0.015625)=X×0.1094≈X×0.1111). The first delay 76a also receives signals input at the first input of the convolver 67 and delays them by the duration of one pixel. The output of the first delay 76a is multiplied by 1/9 by the second multiplier 74a. The outputs of the first and second multipliers 73a, 74a are added together by the first adder 78a. The output of the first delay 76a is further delay by the second delay 77a and then multiplied by 1/9 by the third multiplier 75a. The output of the first adder 78a and the third multiplier 75a are added together by the second adder 79a.

The second and third sections 67b, 67c are similarly constructed from first, second and third multipliers 73b, 73c, 74b, 74c, 75b, 75c, first and second one-pixel delays 76b, 76c, 77b, 77c and first and second adders 78b, 78c, 79b, 79c.

The outputs of the second adders 79a, 79b of the first and second sections 67a, 67b are added together by a first section adder 80. The output of the second adder 79c of the third section is delayed by a delay 81 by an amount corresponding to the delay introduced by the first section adder 80. The outputs of the delay 81 and the first section adder 80 are added together by a second section adder 82 to produce the output of the convolver 67.

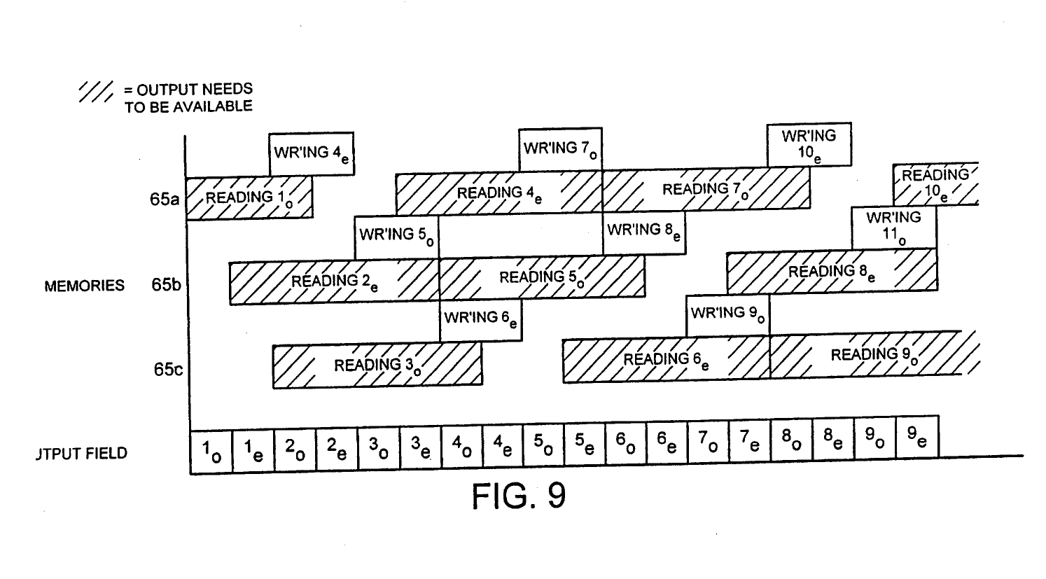

The operation of the decompression apparatus shown in FIG. 7 will now be described with reference additionally to FIGS. 9, 10 and 11.

The Y video component signal from the pre-processor 60 comprises digital sample values for the image portions of the received video signal which are the odd fields of odd frames and the even fields of even frames of the uncompressed video signal. These samples are stored cyclically in the video RAMs 65a, 65b, 65c as shown in FIG. 9. Although the writing of samples to the video RAMs 65a, 65b, 65c is shown as solid blocks, it will be appreciated that these represent a plurality of individual write processes with gaps in between.

The outputting of samples is somewhat more complex. The contents of each video RAM 65a, 65b, 65c are read out according to a cycle comprising reading for one output signal field period, ignoring for one period, reading for three periods, ignoring for two periods, reading for three period and ignoring for one period. This pattern is repeated as long as video signals need processing. The entire contents of a video RAM 65a, 65b, 65c is read out during each read out period. The read out periods are indicated in FIG. 9 by crosshatching.

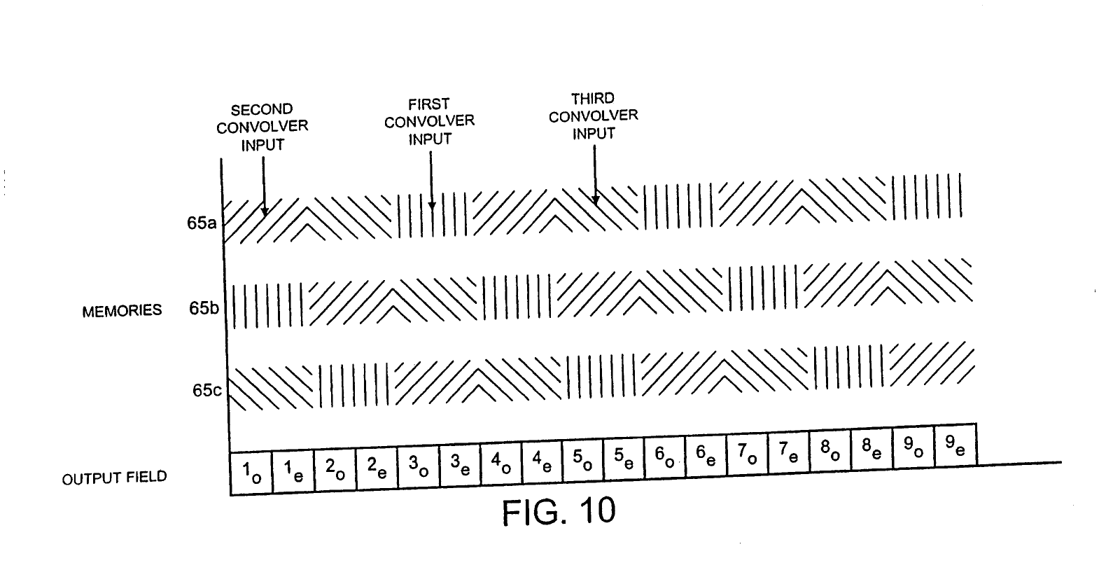

Referring to FIG. 10, the switching matrix 68 is operated so that the each video RAM 65a, 65b, 65c is cyclically connected to each input of the convolver 67 for two output field periods.

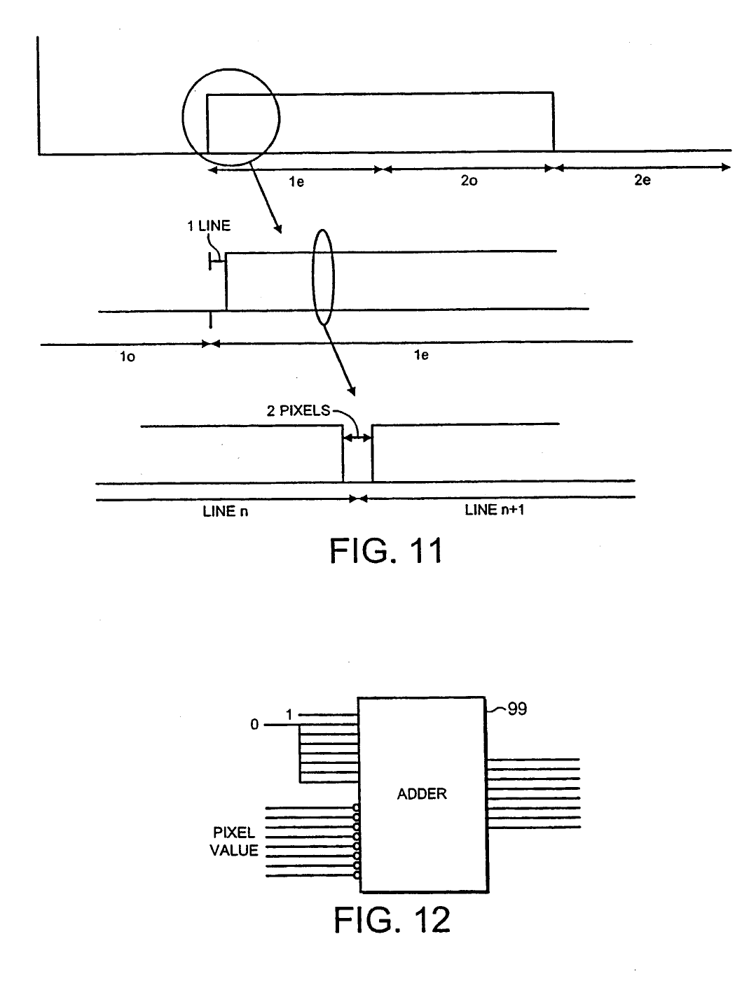

Referring to FIG. 11, for the odd fields of odd frames and the even fields of even frames of the output signal, the switching signal generator 61 produces a signal that causes the second output switch 71 to pass the signal at the second input to the convolver 67. These signals not need to be reconstructed because they have been received in their entirety.

For the output of even fields of odd frames and the odd fields of even frames, the output of the switching signal generator 61 is more complex. Generally, the output of the switching signal generator 61 causes the second output switch 71 to pass the output of the first output switch 70. However, the first lines of these fields cannot be reconstructed because there is no complete line of image data above in the preceding complementary field. Furthermore, the last image line (i.e. line 623 for a PAL signal) of the even fields is only half occupied by image data. Consequently, the switching signal generator 61 causes the second output switching means to briefly switch back to passing the signal at the second input of the convolver 67 which will be the corresponding line of the previous field of the same type for the first lines of even field of odd frames and the odd fields of even frames and for the last line of the even fields of odd frames.

The pixels at the left and right edges of the missing fields cannot be reconstructed by the convolver 67 because of the lack of a preceding or succeeding pixel, as the case may be. To solve this problem, the switching signal generator 61 causes the second output switch 71 to pass the signal on the second input of the convolver 67 for edge pixels.

From the foregoing, it will be apparent that the convolver 67 reconstructs missing odd field using the preceding and succeeding odd fields, which will have been received, and the even field of the same frame. Similarly, the missing even fields are reconstructed using the preceding and succeeding even fields, which will have been received, and the odd field of the same frame. In static areas of the image, particularly where there is fine detail, this process can actually result in degradation of the image. Consequently, the comparing circuit 69 compares the magnitude of the difference between the values at the first and third inputs to the convolver 67 with a threshold value. If the field to be reconstructed is an odd field the preceding and succeeding odd field values are to be found at the first and third inputs. Similarly, if the field to be reconstructed is an even field the preceding and succeeding even field values are to be found at the first and third inputs. In the event that the threshold is exceeded, indicating a significant change in the value of equivalent pixels, interpolation is required and the comparing circuit 69 outputs a signal which causes the first output switch 70 to pass the output of convolver 67. However, if there has been no significant change, the comparing circuit 70 outputs a signal causing the first output switch 70 to pass the value at the first input to the convolver 67.

The output of the second output switch 71 is combined with the U and V components from the other processing circuits by the composite video signal generator 64 to produce a composite video signal.

It will be appreciated than delays may be required, e.g. between the second input of the convolver 67 and the second output switch and between the first input of the convolver 67 and the first output switch 70, to ensure that the signals at the inputs to the second output switch 70 remain in synchronism.

The processing of the edge pixels, top and bottom as well as left and right, can be simplified by simply setting the output pixel to the value required for black in these locations.

A modified convolver 67 is employed in an embodiment which enhances strong vertical and horizontal lines and improves subjective image sharpness. In this case, the convolution mask comprises:

$$\begin{matrix}- 1 & 1 & - 1 \\ 1 & 1 & 1 \\ - 1 & 1 & - 1\end{matrix}$$

rather than

$$\begin{matrix}\frac{1}{9} & \frac{1}{9} & \frac{1}{9} \\ \frac{1}{9} & \frac{1}{9} & \frac{1}{9} \\ \frac{1}{9} & \frac{1}{9} & \frac{1}{9}\end{matrix}$$

Consequently, no multiplication is required where the coefficient is 1.

Referring to FIG. 12, the “multiplier” implementing the −1 coefficients comprises a adder 99 which adds one to the complement of the pixel value (only eight bits shown but it will be appreciated that more bits will preferably be used). A latch may be provided for latching the output to ensure proper timing in the convolver 67.

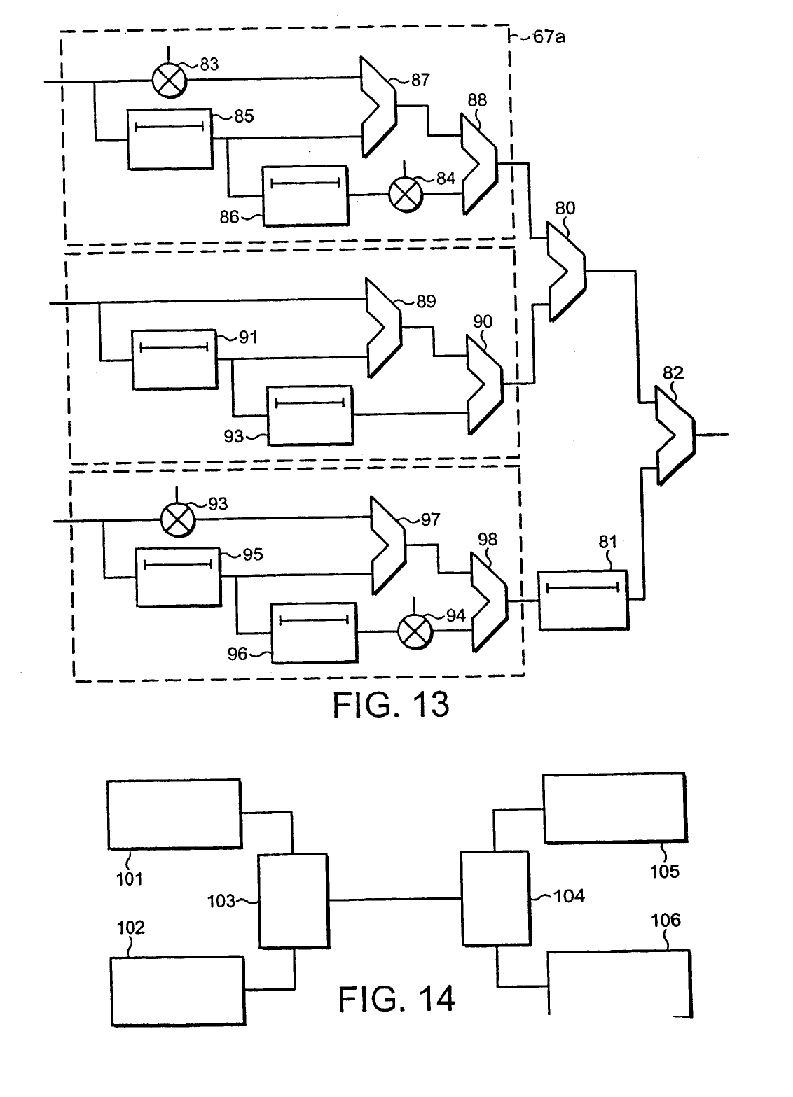

Referring to FIG. 13, the modified convolver 67 comprises first, second and third section 67a, 67b, 67c whose inputs are respectively the first, second and third inputs of the convolver 67.

The first section 67a comprises first and second “multipliers” 83, 84 as shown in FIG. 12, first and second one-pixel delays 85, 86 and first and second adders 87, 88. The first multiplier 83 receives signals input at the first input of the convolver 67. The first delay 85 also receives signals input at the first input of the convolver 67 and delays them by the duration of one pixel. The outputs of the first delay 85 and the first “multiplier” 83 are added together by the first adder 87. The output of the first delay 85 is further delay by the second delay 86 and then input to the second “multiplier” 84. The outputs of the first adder 87 and the second “multiplier” 84 are added together by the second adder 88.

The second section 67b comprises first and second one-pixel delays 89, 90 and first and second adders 91, 92. The input signal is input to the first adder 91 and the first delay 89 and the output of the first delay 89 is also input to the first adder 91 and the second delay 90. The second adder 92 adds the outputs of the first adder 97 and the second delay 90.

The third section 67c is the same as the first section 67a and comprises first and second “multipliers” 93, 94 as shown in FIG. 12, first and second one-pixel delays 95, 96 and first and second adders 97, 98.

The outputs of the second adders 88, 90 of the first and second sections 67a, 67b are added together by a first section adder 80. The output of the second adder 79c of the third section is delayed by a delay 81 by an amount corresponding to the delay introduced by the first section adder 80. The outputs of the delay 81 and the first section adder 80 are added together by a second section adder 82 to produce the output of the convolver 67.

Referring to FIG. 14, the outputs of first and second compression systems 101, 102, as shown in FIG. 1, may be combined by a time-division multiplexer 103 so that frames from the first and second compression systems 101, 102 are alternately sent at twice the rate at which they are output by the compression systems 101, 102. Thus, two video signals can be transmitted in the bandwidth required by one uncompressed signal.

At the receiving end, the multiplexed signal is demultiplexed by a demultiplexer 104 and the demultiplexed signals sent to respective decompression apparatuses 106, 107.

A second embodiment of the present invention will now be described.

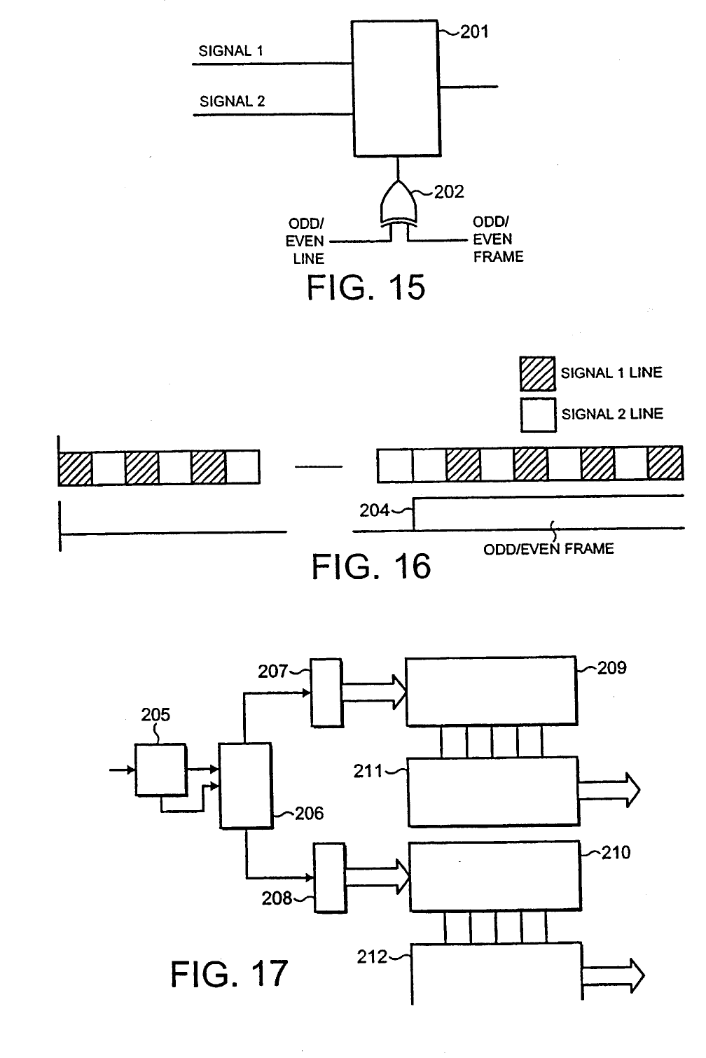

Referring to FIG. 15, two synchronised non-interlaced digital video signals are applied to respective inputs of a multiplexer 201. An “odd/even” line signal, derived from the horizontal sync signal for the video signals, and an “odd/even” frame signal are applied to the inputs of an exclusive OR gate 202. The output of the exclusive OR gate 202 is applied to the control input of the multiplexer 201.

Referring to FIG. 16, the output of the multiplexer 201 comprises data for alternately lines of from the first and second digital video signals. However, at the end of each frame 204, there is a phase shift so that two lines from the same digital video signal are transmitted one after the other.

Referring to FIG. 17, a decompression apparatus for decompressing compressed video produced by the system shown in FIG. 8 comprises a pre-processor 205, a de-multiplexer 206, first and second serial-to-parallel converters 207, 208, first and second shift registers 209, 210 and first and second processors 211, 212.

The pre-processor 205 receives the compressed video and identifies the start of each line and the start of each frame by detecting start of active video and vertical blanking period codes. From these, it generates a control signal for the de-multiplexer 206. The compressed video is output by the pre-processor 205 to the data input of the de-multiplexer 206. According to the control signal from the pre-processor 205, the multiplexer 206 routes data from the first video signal to the first serial-to-parallel converter 207 and data from the second video signal to the second serial-to-parallel converter 208.

The outputs of the serial-to-parallel converters 207, 208 are continuously clocked into respective shift registers 209, 210. The shift registers 209, 210 are one data word wide and 1 830 000 bits long. The shift registers 209, 210 are tapped at the first (pixel₋₂), the 913536^{th} (pixel₋₁), the 915000^{th} (pixel), the 916464^{th} (pixel₊₁) and the 1 830 000^{th} (pixel₊₂) elements. The taps from the first shift register 209 are fed to the first processor 211 and the taps from the second shift register 210 are fed to the second processor 212.

In order to generate each output video data word, the first and second processors 211, 212 perform the following algorithm on the data tapped from the respective shift registers 208, 209:

output ;= 0
if pixel <> 0 then

output := pixel

else

if pixel₋₂ is special code (e.g. start of active video) then

output := pixel₋₂

else
begin

count := 0
for each of taps (pixel₋₂, pixel₋₁, pixel₊₁, pixel₊₂) do
begin

if tap <> 0 then
begin

output := output + tap
count := count + 1

end

end
if count <> 0 then

output := output/count

Thus, if data for a particular pixel has been received it is output. However, if the data for a pixel was removed in the compression stage, it is replaced by a value generated by taking the average of the non-zero pixels immediately above and below in the current frame and in the corresponding position in the preceding and succeeding frames.

It wall be appreciated that the shift register may be implemented using a RAM and a suitable address generator.

It will be further appreciated that circuits of the apparatuses described above may be replaced to a large extent by microcomputer circuits.

The compressed signals produced by the compression systems, described above, may be transmitted in any convenient form and may be subjected to additional compression.

1. A method of compressing a video signal, the method comprising removing a first set of pixels from a first frame of the video signal comprising a plurality of frames and removing a second set of pixels from a second immediately succeeding frame of the video signal, characterised in that the same pixels are not removed from both of said frames.

2. A method according to claim 1, wherein said first set of pixels comprises a first set of lines and the second set of pixels comprises a second set of lines.

3. A method according to claim 2, wherein the first set of lines comprises alternate lines.

4. A method according to claim 3, wherein each frame of the video signal comprised two interlaced fields and the second field is removed from the first frame and the first field is removed from the second frame.

5. A method of transmitting a video signal comprising compressing a video signal by a method according to any preceding claim and transmitting the compressed video signal.

6. A method of transmitting two video signals in one channel, comprising compressing first and second video signals by a method according to any one of claims 1 to 4, and alternately transmitting parts of the first and second video signals remaining after said compression.

7. A method according to claim 6, wherein the transmitted signal comprises alternating frame-sized parts of the first and second video signals.

8. A method according to claim 6, wherein the transmitted signal comprises alternating lines from the first and second video signals.

9. A method of decompressing a video signal produced by a method according to claim 1 or 2, the method comprising:
replacing missing pixels by combining in a predetermined manner spatially and temporally neighbouring pixels.

10. A method of decompressing a video signal produced by a method according to claim 4, the method comprising receiving a frame-sized portion of the compressed signal and outputting said portion twice.

11. A method of decompressing a video signal, the method comprising:
receiving a signal of the form produced by a method according to claim 4; and
replacing missing pixels by combining in a predetermined manner spatially and/or temporally neighbouring pixels.

12. A method according to claim 11, wherein a missing pixel is replaced by selectively outputting a pixel from a previously received field or by outputting the result of said combining in dependence on the difference between the pixels, corresponding to the missing pixel, in the preceding and succeeding received fields of the same type as that for which the missing pixel is being replaced.

13. A method according to claim 11 or 12, wherein missing pixels of an odd field are replaced by combining the corresponding pixels of the preceding and succeeding odd fields, the pixels immediately preceding and succeeding said corresponding pixels, the pixel of the preceding or succeeding even field which is immediately above the pixel to be replaced and the pixels on either side thereof.

14. A method according to claim 13, wherein said combining comprises calculating the mean of the values of said pixels for each of a plurality of video components.

15. A method according to claim 13, wherein said combining comprises, for each of a plurality of video components, convolving the values of said pixels with −1, 1, −1 for the preceding and succeeding odd fields and 1, 1, 1 for said preceding or succeeding even field and summing the results thereof.

16. A method according to claim 11 or 12, wherein missing pixels of an even field are replaced by combining the corresponding pixels of the preceding and succeeding even fields, the pixels immediately preceding and succeeding said corresponding pixels, the pixel of the preceding or succeeding odd field which is immediately above the pixel to be replaced and the pixels on either side thereof.

17. A method according to claim 16, wherein said combining comprises calculating the mean of the values of said pixels for each of a plurality of video components.

18. A method according to claim 16, wherein said combining comprises, for each of a plurality of video components, convolving the values of said pixels with −1, 1, −1 for the preceding and succeeding odd fields and 1, 1, 1 for said preceding or succeeding odd field and summing the results thereof.

19. A video compression apparatus configured to perform a method according to any one of claims 1 to 4.

20. A video decompression apparatus configured to perform a method according to claim 9 or 10.

21. A video decompression apparatus for decompressing video compressed by a method according to claim 4, the apparatus comprising:
memory for storing compressed video signal data;
a convolver for convolving data from said memory with a predetermined mask to regenerate pixels of a field for which data is not contained in the memory; and
switching means for selectively outputting video data for said memory or from the convolver in dependence on the presence of data for the currently output field in the memory.

22. An apparatus according to claim 21, including comparing means for comparing the difference between corresponding pixels of fields output from the memory and a threshold, and further switching means for selectively routing one of said corresponding pixels or the output of the convolver to said switching means for selectively outputting video data in dependence on the output of the comparing means.

23. An apparatus according to claim 21 or 22, including addressing means for controlling writing of data to the memory such that for the regeneration of a pixel of an odd field by the convolver, the memory has available the corresponding pixels of the preceding and succeeding odd fields, the pixels immediately preceding and succeeding said corresponding pixels, the pixel of the preceding or succeeding even field which is immediately above the pixel to be replaced and the pixels on either side thereof.

24. An apparatus according to claim 21 or 22, including addressing means for controlling writing of data to the memory such that for the regeneration of a pixel of an even field by the convolver, the memory has available the corresponding pixels of the preceding and succeeding even fields, the pixels immediately preceding and succeeding said corresponding pixels, the pixel of the preceding or succeeding odd field which is immediately above the pixel to be replaced and the pixels on either side thereof.

25. An apparatus according to any one of claims 21 to 24, wherein the convolver has three sections for processing pixels from respective fields and adding means for summing the outputs of said sections.

26. An apparatus according to claim 25, wherein each section comprises first, second and third multiplying means for multiplying by 1/9 or approximately 1/9, first and second one-pixel delays and first and second adders, the first multiplying means being connected between the section's input and the first adder, the first delay being connected between said input and the second multiplying means, the output of the second multiplying means being connected to the first adder, the second delay being connected between the output of the first delay and the third multiplying means, and the outputs of the third multiplying means and the first adder being connected to the inputs of the second adder.

27. An apparatus according to claim 25, wherein
the sections for processing bits of the preceding and succeeding fields of the same type as that being restored each comprise
first and second multiplying means for multiplying by −1, first and second one-pixel delays and first and second adders, the first delay being connected between the section's input and the first adder, the second delay being connected between the first delay and the second multiplying means, the output of the second multiplying means is connected to the second adder and the output of the first adder being connected to the second adder, and
the other section comprises
first and second one-pixel delays and first and second adders, the first and second delays being connected in series with the first delay connected to the section's input, the first adder having its inputs connected to the section's input and the output of the first delay, and the second adder having its inputs connected to the outputs of the first adder and the second delay.
